(19) United States
(12) Patent Application Publication
(10) Pub. No.: US 2016/0330966 A1
(43) Pub. Date: Nov. 17, 2016

(54) Concentrated Suspension of Agrochemicals in High Electrolyte Aqueous Medium

(71) Applicant: AKZO NOBEL CHEMICALS INTERNATIONAL B.V., Arnhem (NL)

(72) Inventor: Shawn Zhu, Stormville, NY (US)

(73) Assignee: AKZO NOBEL CHEMICALS INTERNATIONAL B.V., Amhem (NL)

(21) Appl. No.: 15/107,725

(22) PCT Filed: Dec. 29, 2014
(86) PCT No.: PCT/EP2014/079355

§ 371 Date: Jun. 23, 2016

Related U.S. Application Data
(60) Provisional application No. 61/922,167, filed on Dec. 31, 2013.

(30) Foreign Application Priority Data
Apr. 11, 2014 (EP) 14164332.0

(51) Int. Cl. A01N 57/20; A01N 51/00; A01N 37/40; C05G 3/02; C05C 3/00; C05G 3/00; A01N 25/04; C05B 7/00; A01N 43/68; A01N 39/04

(52) U.S. Cl. CPC A01N 57/20; A01N 43/68; A01N 51/00; A01N 37/40; A01N 39/04; C05C 3/00; C05G 3/007; A01N 25/04; C05B 7/00; C05G 3/02

(57) ABSTRACT

The present invention generally relates to stable suspension concentrates (SC) displaying shear thinning property and comprising: a water soluble salt, an electrolyte water thickening polymer (eg. xanthan gum or guar gum), an insoluble solid agrochemical and water. The water soluble salt can be an inorganic salt or a pesticide salt (eg. fertilizer or water soluble herbicide such as glyphosate, glufosinate, dicamba, MCPA or 2,4-D); the water thickening polymer is a water soluble polymer capable of fully hydrating and thickening the salt solution (eg. AGHRO DR-2000); and the insoluble solid agrochemical can be a cellulosic derivative MEHEC, a water insoluble pesticide (eg. atrazine, clothianidin or imidacloprid), a water insoluble growth regulator, a water insoluble micronutrient or mixtures thereof. The invention further relates to a method of producing said suspension comprising dissolving thickening polymer in water, adding water soluble salt and adding water insoluble agrochemical.

### FIELD OF THE INVENTION

The present invention generally relates to a solid suspension composition comprising i) at least one electrolyte water thickening polymer, ii) at least one water soluble salt, iii) at least one water insoluble solid agrochemical and iv) water.

### BACKGROUND OF THE INVENTION

Many solid agrochemicals, including herbicides such as atrazine and drift control agents such as cellulosic derived polymer, are in powder form. Handling chemicals in powder form increases potential health issues due to potential inhalation dangers. To minimize this potential danger, solid agrochemicals are often dispersed in water, especially if the solid agrochemical is insoluble or has low solubility in water. This type of stable formulation is commonly referred to as a suspension concentrate (SC) in agriculture applications where the powdered solid is suspended in an aqueous medium.

In SC's, if the density of the solid is higher (or lower) than the aqueous medium, additives are typically utilized to suspend the solid particles and to thicken the aqueous medium to minimize sediment (or flotation).

Suspension of proppant such as sand particles suspended in a thickened electrolyte aqueous medium is well known in oilfield applications. Unlike agrochemical formulations, proppant suspensions for oilfield use typically doesn't require long term stability and the proppant serves as permanent particles even after application. Currently, there are very few known agrochemical formulations containing a solid agrochemical suspended in a high electrolyte aqueous medium. The main reason for this is that it is difficult to control the interaction between the suspended agrochemicals and the electrolyte medium. In fact, most solid agrochemicals are not suitable for a SC formulation in a high electrolyte aqueous medium.

It is a common practice for a farmer or other end-user to add ammonium sulphate (AMS) fertilizer into a glyphosate herbicide tank with additional pesticide. The additional pesticide may be a solid pesticide such as atrazine. Adding various agrochemicals by the tank side is prone to error because end-users sometimes make mistakes in combining chemicals. Therefore, a pre-formulated agrochemical formulation with multiple ingredients not only can provide convenience but also can reduce human error while mixing the chemicals. Therefore, there is a need for a stable suspension concentrate (SC) containing a solid agro chemical suspended in high electrolyte aqueous medium.

Solid agrochemicals differ significantly from typical proppants used in oil field industry as these agrochemicals perform specific biological functions, directly or indirectly, after the formulations are applied. The solid agrochemicals include, but not limited to, pesticides, growth regulators, water-insoluble micronutrients, deposition aids, drift control agents, and the like and/or combinations or mixtures of same. They generally have very limited solubility in the aqueous electrolyte medium before application, i.e., they have very limited interaction with the electrolyte medium before application.

Polymeric cellulosic derivatives are one particular useful class of solid agrochemicals. They have the property of being able to remain as a solid particle in high electrolyte environment until it is diluted to water. Strictly speaking, the polymer cellulosic derivatives utilized in the present invention are water-soluble polymers (WSP) because they eventually hydrate in water with low electrolyte content. Cellulosic derivatives are typically dispersed into water before use. It is well known that evenly dispersing a WSP into water sometimes is a difficult task. When added to water, WSP particles can hydrate in water and form a protective gelled “skin”, preventing the interior of the particle from further hydration. Because of this gelled “skin”, aqueous systems of WSP may contain many gel spots, sometime called “fish eyes”, which can be very difficult to disperse.

To avoid potential “fish eye” issues, various techniques have been developed. One such well-known technique employs a process that mixes the WSP powder in a liquid glycol before adding it to water. Since the WSP doesn't hydrate or doesn't hydrate too quickly in glycol, the glycol can separate the powder particles evenly before adding to water. While this technique can minimize the fish eyes problem, it does require a glycol, which is expensive and does not contribute to the other desired properties of the formulation. In addition, many WSPs may eventually hydrate and gel in glycol.

Another technique described in U.S. Pat. No. 6,639,066 utilizes a suspension composition comprising a solid nonionic cellulosic ether, a salt of polyphosphate, and another salt selected from the group consisting of ortophosphate, pyrophosphate, and sulphate. Since water activity in such a high electrolyte system is greatly reduced due to the hydration from the electrolytes, the left over water molecules are not able to completely hydrate the nonionic cellulosic ether. Hence, the nonionic cellulosic ether powder can be dispersed evenly in high electrolyte aqueous solution. Subsequent addition of such nonionic cellulosic ether dispersion into water can minimize the fish eyes problem. However, the stability data in this patent was for 1 week old suspensions only and there is no mention of stability longer than 1 week. Additionally, this technique is not effective in cases when the nonionic cellulosic ether dispersion, i.e., more correctly suspension, needs to be stored for a substantial length of time before addition to water.

U.S. Pat. Nos. 5,837,864 and 5,898,072 disclose suspensions having a cross-linked cellulose ether. U.S. patent application Ser. No. 12/845,861 discloses a suspension that is not an electrolyte solution. U.S. patent application Ser. No. 11/476,655 discloses a suspension having multiple anionic surfactants. EP0268574 discloses a suspension having nonylphenol ethoxylates. EP0413274 discloses a suspension requiring a wetting agent.

### SUMMARY OF INVENTION

The present invention generally relates to a solid suspension composition comprising i) at least one electrolyte water thickening polymer, ii) at least one water-soluble salt, iii) at least one water insoluble solid agrochemical and iv) water.

The water-soluble salt is an electrolyte and can be an inorganic salt or a pesticide salt; the electrolyte water thickening polymer is a water soluble polymer capable of fully hydrating and thickening the salt solution; and the water insoluble solid agrochemical, can be a cellulosic derivative, and/or a water insoluble solid pesticide. In one embodiment, the electrolyte water thickening polymer is a polysaccharide thickener comprising guar gum. References to guar gum herein include nonionic guar gum (including hydroxyl propyl guar gum), cationic guar gum (including quaternary guar gum), anionic guar gum, amphoteric guar gum, and/or combinations and mixtures thereof.

The invention also relates to a method of dispersing a solid agrochemical into a shear thinning aqueous electrolyte solution thickened by an electrolyte water thickening polymer. The thickened electrolyte solution is shear thinning so that at rest the solid particles can be suspended by the high viscosity provided by the electrolyte water thickening polymer and while pouring the viscosity drops to allow easy flow of the product. When the dispersed solid is a cellulosic derivative, the concentration of the electrolyte is required to be high enough to supress the hydration of the dispersed solid cellulosic derivative but not too high to affect the thickening ability of the electrolyte thickening polymer.

### DETAILED DESCRIPTION OF INVENTION

The present invention generally relates to a solid suspension composition comprising i) at least one electrolyte water thickening polymer, ii) at least one water-soluble salt, iii) at least one water insoluble solid agrochemical and iv) water.

The electrolyte water thickening polymer is a water soluble polymer capable of thickening an aqueous electrolyte medium while producing shear thinning property. In one embodiment the electrolyte water thickening polymer is a guar gum derivative with different charge types. In another embodiment the guar gum derivative is a hydroxyl propyl guar gum or a quaternary guar gum.

The concentration of the electrolyte water thickening polymer in the composition of the present invention is from about 0.1 to about 2 wt %, in another embodiment from about 0.3 to about 1 wt %.

Generally, use of more than about 1.5 wt % guar gum in the water soluble suspensions is not necessary unless a very thick or gelled product is desired. Guar gum has the ability to prevent the lateral flogging while at the same time modifying the density of the electrolyte solution to minimize settling.

The water soluble salts, i.e., the electrolyte, useful in the context of the present invention are ionic compounds that can dissolve and dissociate easily into cations and anions in water. Non-limiting examples of cations are ammonium, lithium, sodium, calcium, magnesium, aluminium, copper, isopropylamine, dimethylamine, monoethanolamine, diethyleneamine, diethanolamine, triethanolamine, paraquat herbicide, and mixture of them. Non-limiting examples of anions are sulphate, sulphite, chloride, nitrate, bromide, fluoride, carbonate, bicarbonate, phosphate, biphosphate, glyphosate herbicide anion, 2,4-D herbicide anion, MCPA herbicide anion, dicamba herbicide anion, glufosinate herbicide anion, and mixtures of them. In one embodiment, the ionic compounds are salts of glyphosate, salts of 2,4-D, salts of dicamba, salts of glufosinate, ammonium sulphate, calcium chloride, sodium chloride, magnesium chloride, sodium bromide, sodium sulphate, ammonium bicarbonate, ammonium carbonate, sodium carbonate, ammonium nitrate, and mixture of them. The concentration of the ionic compounds is generally greater than about 15 wt %, in another embodiment from about 15 to about 65 wt %, in another embodiment from about 15 to about 50 wt %, in yet another embodiment from about 15 to about 40 wt %, and in still another embodiment from about 20 to about 30 wt %.

The particular electrolyte to be used can be highly system specific, and is influenced by the specific components of the composition. Some systems only function well if a particular ionic compound is included in the composition, and will not function properly if other ionic compounds are substituted.

In one embodiment, the water insoluble solid agrochemical to be suspended is a cellulosic derivative. The concentration of the cellulosic derivative is generally from about 3 to about 40 wt %, in another embodiment from about 5 to about 35 wt %, in yet another embodiment from about 10 to about 30 wt %, and in still another embodiment from about 15-25 wt %.

In one embodiment, the cellulosic derivative is a methyl ethyl hydroxyl ethyl cellulose derivative (MEHEC) as disclosed in U.S. Pat. No. 6,639,066 and WO201280301A2, which are incorporated herein by reference. The insolubility of MEHEC in the context of the present invention refers to the lack of thickening of the aqueous medium after adding MEHEC. This can be measured by comparing the viscosities of an electrolyte system without MEHEC and with intended amount of MEHEC. If the viscosity of the electrolyte system with MEHEC is similar to the viscosity without MEHEC, MEHEC is considered insoluble in the electrolyte system. In this case, MEHEC remains non-hydrated and MEHEC particles still have defined shape which can be observed under an optical microscope. In circumstances where the electrolyte concentration is above about 15%, the MEHEC generally is water insoluble because the electrolyte concentration is high enough to suppress its hydration, rendering it insoluble.

Cellulosic derivatives such as MEHEC are agrochemicals that reduce the amount of fine droplets of agricultural formulations, which helps control drift of the agricultural formulations. MEHEC's usefulness as an agrochemical is illustrated, for example, at Example 10 below.

Preferably, the cellulosic derivative used in the compositions of the present disclosure is linear, non-cross linked polymer.

In another embodiment, the water insoluble solid agrochemical to be suspended is a water insoluble solid pesticide or a growth inhibitor. The concentration of the pesticide or growth inhibitor is from about 5 to about 50 wt %, in another embodiment from about 5 to about 35 wt %, in another embodiment from about 10 to about 30 wt %, and in yet another embodiment from about 15 to about 25 wt %. Examples of water insoluble pesticides usefully employed in the context of the present invention include, but are not limited to atrazine herbicide, diuron herbicide, captan fungicide, clothianidin insecticide, neonicotinoids insecticide such as imidacloprid, azoxystrobin fungicide, and the like.

The product of the present invention is storage stable and has no significant separation, no lumps and no significant increase in viscosity after long term storage tests (>4 weeks) at a temperature <50° C. The product can be re-mixed easily, even if some settling does occur, and can be re-dispersed into water easily.

Water soluble salts in the specification are pesticide salts and inorganic salts that have at least 20% solubility at 25° C. in water, in another embodiment at least 40% solubility at 25° C. in water.

Water insoluble pesticides in the specification have less than 2 wt %, preferably less than 1 wt %, and more preferably less than 0.1 wt % solubility at 25° C. in water.

Other minor and/or optional components can be added to the compositions of the present invention. These components include, but are not limited to surfactants, antimicrobials and the like. However, due to the high electrolyte content in the suspension, use of antimicrobials may not be necessary.

The invention also relates to a method of producing a storage stable (<˜40° C.) aqueous solid suspension of an agrochemical in a thickened electrolyte medium which comprises (1) preparing a thickened and shear thinning electrolyte aqueous solution by adding and mixing a electrolyte water thickening polymer at 0.1-2 wt % in water in a vessel until the electrolyte water thickening polymer is fully hydrated or until the viscosity is developed, (2) followed by adding more than about 15% water soluble salt; and (3) adding and mixing more than about 3 wt % of a solid agrochemical into the thickened system to form a suspension concentrate.

The invention also relates to another method of producing a storage stable (<˜40° C.) aqueous solid suspension of an agrochemical in a thickened electrolyte medium which comprises (1) adding and dissolving at least about 15 wt % one water soluble salt in water first in a vessel, (2) followed by adding and mixing 0.1-2 wt % at least one electrolyte water thickening polymer selected from guar gum and its derivatives in the vessel until the electrolyte water thickening polymer is fully hydrated or until the viscosity has been developed, (3) and further followed by mixing more than about 5% of at least one water insoluble solid agrochemical into the vessel until a homogeneous suspension composition is obtained, where the suspension composition displays shear thinning property with a viscosity less than 30000 cps, as measured at about 25° C. with a Brookfield viscometer DV-II Pro with a spindle #64 at 60 RPM.

The invention will further be illustrated by the following non-limiting examples. Viscosity measurement of all samples was performed with a Brookfield viscometer DV-II+Pro using a #64 spindle at room temperature.

### EXAMPLE 1

21.38 grams ammonium sulphate (AMS) were added into 52.87 grams water with agitation until AMS fully dissolved. 0.75 grams AGRHO® DR-2000 (hydroxyl propyl guar gum from Rhodia) was then added into this AMS solution, which was mixed until guar gum fully hydrated and the mixture reached a stable viscosity. 25 grams of MEHEC was then added under vigorous mixing until the composition was lump-free (a smooth suspension). The viscosity of this MEHEC suspension is shown in Table 1.

TABLE 1
Viscosity of 25% MEHEC suspension in example
1 after 5 days at ~20° C.

| RPM | Viscosity, cps |
|---|---|
| 1.5 | 17200 |
| 3 | 11400 |
| 12 | 6800 |
| 30 | 4200 |
| 60 | 2800 |

The sample shows a strong shear thinning property. This sample does not freeze at ˜0° C. and it still flows quite easily at this temperature. It becomes viscous at ˜−10° C. The viscosity of the sample did not substantially change after 3 freeze-thaw cycles (−30° C./room temperature). The sample had a clear phase at bottom (˜10% in volume) after 4 weeks placed in a 50° C. oven. The top phase was still uniform. The sample could be re-mixed easily into a uniform sample and remained with little separation below room temperature.

### EXAMPLE 2

10-30% AGRHO DR-2000 in 20-40% AMS forms a gel (non-flowable). This illustrates that guar gum cannot be used to suspend itself.

### EXAMPLE 3

0.7 grams TIC Pretested® Ticaxan® Xanthan Powder (Xanthan gum) was added to 99.3 grams water under vigorous mixing. The xanthan gum was able to fully hydrate into a viscous solution. 30 grams of AMS added to this xanthan gum solution did not de-hydrate the xanthan gum, i.e., the xanthan gum did not coagulate together into lumps and did not squeeze out the water. The viscosity of this xanthan gum solution remained relatively unchanged. This xanthan gum solution is useful to suspend water insoluble solid agrochemicals.

### EXAMPLE 4

30 grams of AMS was added to 99.3 grams water with mixing until the AMS dissolved. 0.7 gram TIC Pretested® Ticaxan® Xanthan Powder (Xanthan gum) was then added. Example 4 has the same composition as Example 3, but was created with a different process. The xanthan gum of this example did not fully hydrate xanthan gum particles. The suspension medium prepared as described in this example is not preferred to suspend water insoluble solid agrochemicals.

Comparing example 3 and 4, it can be seen that preferably xanthan gum needs to hydrate in water prior to adding electrolytes.

### EXAMPLE 5

2.6 grams TIC Pretested® Ticaxan® Xanthan Powder (Xanthan gum) was added to 537.4 grams water with mixing until xanthan gum fully hydrated to a uniform solution. 210 grams AMS was then added to this solution with stirring until AMS fully dissolved. 250 grams MEHEC was added under vigorous mixing using an overhead stirrer until a lump-free, smooth suspension was obtained. Total sample size was 1000 g. This sample flowed smoothly. The viscosity of this MEHEC suspension is shown in Table 2.

TABLE 2
Viscosity of 25% MEHEC suspension in example 5

| RPM | Viscosity (day 1), cps |
|---|---|
| 1.5 | 34000 |
| 3 | 23000 |
| 6 | 15000 |
| 12 | 9200 |
| 30 | 4600 |
| 60 | 2900 |

This sample was divided into four parts. Part 1 was stored at 50° C. Part 2 was kept on the lab bench at room temperature (˜22° C.). Part 3 was stored at low temperature (0˜−5° C.). Part 4 was used for a freeze/thaw (F/T) study. The storage stability of this sample is shown in Table 3.

TABLE 3
Storage stability of Example 5.

| | 50° C. | ~22° C. | 0~−5° C. |
|---|---|---|---|
| 5 days | No separation, no | No separation, no | No separation, no |
| | coagulation, sample | coagulation, sample | coagulation, sample |
| | uniform. | uniform. | uniform. |
| 7 days | ~1% top clear. No | No separation, no | No separation, no |
| | coagulation, sample | coagulation, sample | coagulation, sample |
| | uniform. Then sample is | uniform. | uniform. |
| | moved to room temp. | | |
| 28 days | ~5% top clear. No | ~1% top clear. No | No separation. No |
| | coagulation, flow easily, | coagulation, flow easily, | coagulation. Viscous but |
| | sample uniform. Re-mix | sample uniform. Re-mix | flowable at 0 C. Flow |
| | easily. Viscosity (60 | easily Viscosity (60 | easily after it returns |
| | RPM) = 550 cps. | RPM) = 400 cps. | to room temp. Sample |
| | | | uniform. |

The sample is freeze/thaw stable after 3 cycles of F/T.

Example 5 demonstrate that the MEHEC suspension is very easy to handle and is stable below room temperature and relatively stable at 50° C., even with a relatively low viscosity. The loss of viscosity may have been due to bacterial growth in the sample since no antimicrobial was added.

### EXAMPLE 6

0.8 gram Jaguar® C-14S (cationic guar from Rhodia) was added to 99.2 gram water with mixing. ˜0.07 gram 40% citric acid aqueous solution was added to thicken the system. 38.9 grams AMS was then added with mixing. The viscosity decreased somewhat compared to Example 1, but the viscosity was sufficient to suspend water insoluble solid agrochemicals. The system is shear thinning. 75 grams of this sample was added to 25 grams MEHEC and this mixture was homogenized until the sample was uniform. This sample was stored at 50° C. for 7 days with no visible separation that occured. The sample is very viscous at room temperature because of the high concentration of Jaguar® C-14S.

### EXAMPLE 7

0.53 gram Jaguar® C-14S (cationic guar from Rhodia) was added to 100.29 grams water with mixing. ˜0.08 gram 40% citric aqueous solution was then added to thicken the system. 38.94 grams of AMS was then added with mixing. The system is shear thinning. Finally 46.61 grams MEHEC was added and the suspension was homogenized until the sample was uniform. This sample contained 0.284% Jaguar C-14S, 53.80% water, 0.043% 40% citric acid, 20.885% AMS, and 25.00% MEHEC. The sample had good flowability. The viscosity at 22.5° C. is shown in Table 4. This sampled was stored at 50° C. for 3 days, with relatively no change to viscosity or visible separation.

TABLE 4
Viscosity of freshly prepared sample in example 7

| RPM | Viscosity, cps |
|---|---|
| 1.5 | 13000 |
| 60 | 1300 |

### EXAMPLE 8

0.7 g Jaguar C-14S was added to 27.47 g water with mixing. 76 g K-glyphosate (62% active ingredient) was then added with mixing until the viscosity was developed into a stable value (<30 minutes). 9.8 g of atrazine (a powder herbicide) was then added and the suspension was mixed until uniform. This sample exhibited good viscosity and stability with <5% separation at room temperature and <˜10% separation at 50° C. for 1 month. This sample still flowed easily without lumps.

### EXAMPLE 9

10 g water was mixed with 10 g 10-34-0 fertilizer (a clear ammonium poly-phosphate solution with 10% N and 34% P₂O₅). 0.2 g AGRHO DR-2000 was added and mixed well. A thickened solution with good viscosity was obtained. 2.24 g imidacloprid insecticide powder was added and mixed well. A stable and flowable imidacloprid suspension was obtained.

Adding a small amount (e.g. about 1 to 2 percent) of a wetting agent Witconate NAS-8 (sodium octane sulfonate) helps to disperse imidacloprid powder in the system.

### EXAMPLE 10

A composition containing 38.73 wt % IPA-glyphosate (˜62% ai), 45.47 wt % K-glyphosate (˜46% ae), 10 wt % tallow/cocoamine ethoxylate, 0.8 wt % AGRHO DR-2000, and 5% MEHEC was created in a bottle. Guar gum DR-2000 and MEHEC were blended together separately and added to the composition after the remaining components were mixed together. The composition was mixed using an overhead stirrer for 30 minutes. This composition was stable (no sign of separation at room temperature for 3 months). Drift measurement were performed of 0.5%, 1% and 2% of this sample in water under spray pressures of 30, 40, ad 60 PSI using a flat fan nozzle. Drift measurement on a formulation without MEHEC drift control agent and guar gum DR-2000 were also performed. The data is shown in the Table 5.

TABLE 5
Reduction of Fine Droplets Due To Agrochemical MEHEC

| | | % reduction of fine droplets | |
|---|---|---|---|
| | Spray | (<150 μm) compared to the | % fine |
| | Pressure, | sample without MEHEC | droplets |
| | psi | and DR-2000 | in <150 μm |
| 0.5% sample | 30 | 31 | 31 |
| 1% sample | 30 | 50 | 24 |
| 2% sample | 30 | 73 | 13 |
| 0.5% sample | 40 | 27 | 40 |
| 1% sample | 40 | 44 | 32 |
| 2% sample | 40 | 65 | 21 |
| 0.5% sample | 60 | 19 | 50 |
| 1% sample | 60 | 35 | 40 |
| 2% sample | 60 | 62 | 26 |

The data shows that the agrochemical MEHEC acts as a drift control agent to reduce the amount of fine droplets (<150 μm) by 19% to 73% depending on the dilution concentration and spray pressure.

### EXAMPLE 11

The effect of guar gum on the stability of a clothianidin fertilizer SC was analyzed. Two samples are shown in table 6 below. In sample A, URAN 28 fertilizer was combined with DR-2000 guar gum and clothianidin insecticide in the amounts described in Table 6. In Sample B, URAN 32 fertilizer (˜80% solid with ˜45% ammonia nitrogen and ˜34.8% urea in ˜20% water) was combined with DR-2000 guar gum, wetting agent Witcolate D-510 (2-ethylhexyl sulfate), and citric acid.

TABLE 6
Clothianidin SC in URAN fertilizer

| Sample | A | B |
|---|---|---|
| URAN 28 | 59.54 (wt %) | |
| URAN 32 | | 58.51 (wt %) |
| Witcolate D-510 | | 1.33 (wt %) |
| AG-RHO DR-2000 | 0.3 (wt %) | 0.3 (wt %) |
| Citric acid (40%) | | 0.4 (wt %) |
| Clothianidin | 40.16 (wt %) | 39.46 (wt %) |
| Mixing method | Homogenized | Hand shake |
| Comment | Room temp 1 month | Room temp 2 |
| | ~15% top clear | month <10% |
| | | top clear |

The data shows that samples A and B containing 0.3 wt % guar gum DR-2000 were stable at room temperature after 1 month and 2 months, respectively.

As exemplified above, the compositions of the present disclosure provide a useful suspension concentrate for use with insoluble solid agrochemicals. Beneficially, the compositions of the present disclosure provide suspension concentrates without the need for surfactants to be included in the composition. In particular, the use of nonylphenyl derivatives can be avoided, which reduces the potential toxicity of the composition. Other surfactants such as TSP phosphate esters can also be avoided, and are not necessary for the compositions of the present disclosure.

1. An aqueous suspension composition comprising i) at least one water soluble salt having at least 20% solubility at 25° C. in water, ii) at least one electrolyte water thickening polymer capable of thickening the composition selected from the group consisting of xanthan gum, xantham gum derivatives, guar gum, guar gum derivative, or a mixture thereof, iii) at least one solid agrochemical selected from the group consisting of methylethyl hydroxylethyl cellulose, a water insoluble pesticide having less than 2 wt % solubility at 25° C. in water, a water insoluble growth regulator having less than 2 wt % solubility at 25° C. in water, a water insoluble micronutrient having less than 2 wt % solubility at 25° C. in water, and combinations and mixtures thereof, and the remainder water, wherein the composition displays shear thinning property and has a viscosity of less than 30000 cps at 25° C. as measured by a Brookfield viscometer DV-II Pro with a spindle #64 at 60 RPM, and wherein the concentration of the water soluble salt is from 15 to 70 wt %, the concentration of the electrolyte water thickening polymer is from 0.1 to 2 wt %, the concentration of the solid agrochemical is from 3 to 50 wt %, balanced with water to 100 wt %.

2. The composition of claim 1 wherein the water soluble salt is a fertilizer.

3. The composition of claims 1 wherein the solid agrochemical is an herbicide.

4. The composition of claim 3 wherein the solid agrochemical is atrazine.

5. The composition of claim 1 wherein the solid agrochemical is an insecticide.

6. The composition of claim 5 wherein the solid agrochemical is clothianidin.

7. The composition of claim 5 wherein the solid agrochemical is imidacloprid.

8. The composition of claim 2 wherein the water soluble pesticide salt is glyphosate salt, dicamba salt, 2,4-D salt, MCPA salt, glufosinate salt, or mixtures or combinations thereof.

9. The composition of claim 2 wherein the water soluble salt is further combined with a water soluble pesticide salt.

10. A method of preparing an aqueous liquid suspension composition comprising mixing at least one electrolyte water thickening polymer in water selected from the group consisting of xanthan gum, xanthan gum derivatives, guar gum, guar gum derivative, or a mixture thereof in a vessel until the electrolyte water thickening polymer is fully hydrated or until the viscosity has been developed in order to obtain a premix, mixing at least one water soluble salt having at least 20% solubility at 25° C. in water with the premix, and further followed by mixing at least one solid agrochemical selected from the group consisting of methylethyl hydroxylethyl cellulose, a water insoluble pesticide having less than 2 wt % solubility at 25° C. in water, a water insoluble growth regulator having less than 2 wt % solubility at 25° C. in water, a water insoluble micronutrient having less than 2 wt % solubility at 25° C. in water, and combinations and mixtures thereof into said premix until a homogeneous suspension composition is obtained; wherein the suspension composition displays shear thinning property with a viscosity less than 30000 cps, as measured at about 25° C. with a Brookfield viscometer DV-II Pro with a spindle #64 at 60 RPM, and wherein the concentration of the water soluble salt is from 15 to 70 wt %, the concentration of the electrolyte water thickening polymer is from 0.1 to 2 wt %, the concentration of the solid agrochemical is from 3 to 50 wt %, balanced with water to 100 wt %.

11. The method of claim 10 wherein the water soluble salt is further combined with a water soluble pesticide salt.

12. The method of claim 11 wherein the soluble pesticide salt selected from the group consisting of a glyphosate salt, dicamba salt, 2,4-D salt, or glufosinate salt, and combinations and mixtures thereof.

13. The method of claim 10 wherein the electrolyte water thickening polymer is non-derived or derived guar gum.

14. An aqueous suspension composition created from claim 10 wherein the electrolyte water thickening polymer is xanthan gum or xanthan gum derivative.

15. An aqueous suspension composition comprising i) at least one water soluble salt having at least 20% solubility at 25° C. in water, ii) at least one electrolyte water thickening polymer selected from the group consisting of xanthan gum, xanthan gum derivatives, guar gum, guar gum derivative, or a mixture thereof, iii) at least one solid agrochemical selected from the group consisting of methylethyl hydroxylethyl cellulose, a water insoluble pesticide, a water insoluble growth regulator, a water insoluble micronutrient, and combinations and mixtures thereof, and the remainder water, wherein the composition displays shear thinning property and has a viscosity of less than 30000 cps at 25° C. as measured by a Brookfield viscometer DV-II Pro with a spindle #64 at 60 RPM.

16. A method of preparing an aqueous liquid suspension composition comprising the steps:
(i) first adding and dissolving at least one water soluble inorganic salt having at least 20% solubility at 25° C. in water in a vessel,
(ii) next adding and mixing at least one electrolyte water thickening polymer selected from guar gum and its derivatives in the vessel until the electrolyte water thickening polymer is fully hydrated or until the viscosity has been developed,
(iii) next mixing at least one solid agrochemical selected from the group consisting of methylethyl hydroxylethyl cellulose, a water insoluble pesticide, a water insoluble growth regulator, a water insoluble micronutrient, and combinations and mixtures thereof into the vessel until a homogeneous suspension composition is obtained; wherein the suspension composition displays shear thinning property with a viscosity less than 30000 cps, as measured at about 25° C. with a Brookfield viscometer DV-II Pro with a spindle #64 at 60 RPM and wherein the concentration of the water soluble salt is from 15 to 70 wt %, the concentration of the electrolyte water thickening polymer is from 0.1 to 2 wt %, the concentration of the solid agrochemical is from 3 to 50 wt %, balanced with water to 100 wt %.

17. The method of claim 16 wherein the water soluble salt is further combined with a water soluble pesticide salt.

18. The method of claim 17 wherein the soluble pesticide salt is selected from the group consisting of a glyphosate salt, dicamba salt, 2,4-D salt, or glufosinate salt, and combinations and mixtures thereof.
